(19) United States
(12) Patent Application Publication
(10) Pub. No.: US 2023/0144402 A1
(43) Pub. Date: May 11, 2023

(54) APPARATUS PROVIDING CAPABILITIES FOR PRINTING ONTO A PLURALITY OF SPHERICALLY SYMMETRICAL OBJECTS FOR FLATBED PRINTING DEVICES

(71) Applicants: James Camron Smalley, Orlando, FL (US); James Edwin Smalley, JR., Orlando, FL (US)

(72) Inventors: James Camron Smalley, Orlando, FL (US); James Edwin Smalley, JR., Orlando, FL (US)

(21) Appl. No.: 18/048,994

(22) Filed: Oct. 24, 2022

Related U.S. Application Data
(60) Provisional application No. 63/276,104, filed on Nov. 5, 2021.

(51) Int. Cl. B41F 17/30

(52) U.S. Cl. CPC B41F 17/30

(57) ABSTRACT

An apparatus for printing on spherically symmetrical objects configured to secure a plurality of spherically symmetrical objects between detents at once comprising a driving assembly, followed by a baseplate driving end, followed by a spherically symmetrical object, followed by several ball-cup assemblies enclosing the spherically symmetrical objects, followed by a ball-release assembly, enclosed by a baseplate holder end, mounted to a baseplate with a quick release system supporting. The apparatus is developed to interface with a rotary rack to allow for the rotation of the spherically symmetrical objects by way of converting the linear motion of a flatbed printer to rotational motion in the detents to which the spherically symmetrical objects are held. Additionally, a spring of appropriate stiffness is used to form a rigid rod of the respective spherically symmetrical objects within the confines of the cupping assemblies allowing for incremental printing, and release, of enclosed objects.

### CROSS-REFERENCE TO RELATED APPLICATIONS

This application is a continuation of Provisional U.S. Pat. Application Ser. No. 63/276,104, filed Nov. 5, 2021.

### FIELD OF THE INVENTION

The present invention relates to an apparatus that grips spherically symmetrical objects to facilitate printing images across the circumference of spherically symmetrical objects utilizing a flatbed printing device. Specifically, the invention provides an apparatus with a quick-release mechanism, which when placed within the confines of a flatbed printer, facilitates printing onto a plurality of spherically symmetrical objects in succession.

### BACKGROUND OF THE INVENTION

With the development of fast-curing flatbed printers capable of printing color-rich textured or embossed features, there has been a significant increase of a sector of print shops dedicated to printing designs directly onto accessories, giftware, ceramics, and many more products. These objects are planar in geometry and easily compatible with a stock flatbed printer setup.

With a market saturated in planar objects, an increased market demand has arisen for developing various apparatuses and machines that provide the customization, via printing, of non-planar objects such as spheres, cylinders, and similar non-planar shapes.

Various efforts exist to develop devices and methods for printing on such spherically symmetrical objects. One such effort involves placing a fixture inside a flatbed printer with several rows and columns of spherically symmetrical objects. Devices designed this way focus on a fixture that orients the spherically symmetrical object such that a single plane tangent to the surface of the printhead is available to be imprinted upon, like a pad printing process. See JP 2010-162265 A of Matsui et al.

Other efforts involve the development of a computer-controlled apparatus for printing specifically on spherically symmetrical objects. See Pub. No. US 2005/0178279 A1 of Valls, Pat. No. US 6,418,843 B1 of Givler, Pat. No. US 6,538,767 B1 of Over et al., and Pub. No. US 2009/0255423 A1 of Valls. Similarly, additional efforts focus on computer-controlled machinery with a high throughput of printed objects for mass production. See Pub. No. 2011/0292146 A1 of Sigismondo and KR 20-0492888 Y1 of Jaehoon.

It is evident that there has been development of accessories for flatbed printers that allows for printing onto a single tangent plane of a spherically symmetrical object, and there have been additional efforts into the development of novel machines for printing fully around a spherically symmetrical object. From these current efforts, it becomes apparent that there is a need for an apparatus to convert commonly used flatbed printers to be capable of printing fully around spherically symmetrical objects. This invention seeks to meet the needs of modern print shops to adapt their current equipment to implement various marketable products.

### BRIEF SUMMARY OF THE INVENTION

The present invention addresses the problems described above by providing an apparatus for use with currently marketed flatbed printers, acting as an accessory, allowing for printing onto spherically symmetrical objects having curved, non-planar, or non-linear surfaces. These objects include, but are not limited to, spherically symmetrical objects such as golf balls, ping pong balls, and ornaments.

A system, according to a preferred embodiment of the invention, includes a spherically symmetrical object holder assembly composed of multiple detents throughout which spherically symmetrical objects are held together via spring compression. Two end mounts enclose the holding assembly, a driving end mount and a reload end mount, and are attached to a baseplate. Between the end mounts, ball-cup assemblies hold the spherically symmetrical objects. In the invention’s preferred embodiment, a driving end mount houses a bearing by which a cup attaches and can rotate. The cup’s design consists of a hollowed cylindrical volume with a chamfered edge conforming to the spherically symmetrical object’s radius, such that a spherically symmetrical object is partially contained inside the volume of the cup while a volume remains open for printing. Following the placement of an object into the initial cup, a ball-cup assembly is seated upon two rails that run transverse to the holding assembly; the rails attach to the two end mounts and allow for longitudinal adjustment of the ball-cup assembly. The ball-cup assembly contains a bearing housing that affixes to the rails, and upon the front and back face of the assembly, an aforementioned cup for gripping the spherically symmetrical object is attached. The assembly holds the back end of one spherically symmetrical object on the front-facing side and the front end of one spherically symmetrical object on the back-facing side. This process of cupping an object via ball-cup assemblies repeats until, in the preferred embodiment, three spherically symmetrical objects are held between the two ends of the holding assembly. The final ball-cup assembly, closest to the reload end mount, features a gripping handle on the back face instead of a cup. This specific ball-cup assembly is known as the ball-release assembly, and between the casing of the ball-release assembly and the reload end mount sits a spring on each rail. The spring is contained between the ball-release assembly and reload end mount, compressing along the length of the rails. When the spring is partially disengaged, the spherically symmetrical objects align to the center of the cups and the cups, attached to the ball-cup housing with a bearing inside, create a rigid rod with which the object and cups can rotate. When the spring is engaged by pulling the gripping handle and securing it to the reload end mount, the spherically symmetrical objects are released from the cups at a prescribed distance and sit on a chamfered edge atop the baseplate, allowing for replacement of the objects.

One aspect of the present invention is the ability to rotate a plurality of spherically symmetrical objects as previously described in the holding assembly. A rotary rack [a piece of equipment used with flatbed printers to allow for printing on cylindrical objects by converting the longitudinal motion of the flatbed into rotational motion in the rotary rack rollers] is used to accomplish this function. The present invention interfaces with the rotary rack via a quick-release front mount and a quick-release end mount. The quick-release front mount has a recessed shelf into which the holding assembly is inserted. The quick-release end mount consists of one piece with two small tabs on the ends that slot into the sides of the holding assembly. A driving assembly is attached to the quick-release front mount through a fastener. Both quick-release parts attach to the mounting holes available on a rotary rack device. These quick-release pieces fix the holding assembly in all directions except directly above, respectively, preventing assembly movement during rotation while allowing movement when replacing the objects in the holders. To interface between the rotary rack and the driving assembly, a belt is connected to the rotary rack rollers and situated onto a groove of a pulley connected to the driving assembly, allowing for the transmission of the rotational motion of the rotary rack rollers to the driving assembly pulley. The driving assembly comprises the aforementioned pulley, a bearing housing affixed to the quick-release front mount, a keyed shaft, and a gear. The pulley runs through the bearing housing, and a fastener connects the pulley to the keyed shaft where the gear is mounted. The same keyed shaft and gear are set on the opposite face to the cup of the previously mentioned driving end mount. These shafts offset one another the distance of the diametral pitch of the gear, such that the holding assembly gear meshes with the driving assembly gear allowing for the rotation of the spherically symmetrical objects for printing.

Accordingly, it is an objective of the presented invention to provide an accessory to a standard flatbed printer that interacts with a rotary rack to allow the printer’s conversion from working with planar objects to spherically symmetrical objects.

An additional objective is to hold a plurality of spherically symmetrical objects between detents by which the objects can be loaded and unloaded by compressing a spring via pulling a gripping handle and fastening it to the reload end mount therebetween the spring resides.

Another objective of this invention is to provide a system for quick-release where many baseplate assemblies can be prepared and quickly mounted and unmounted from the quick-release assembly without the need for fasteners.

These and other objects, aims, and advantages of the presented invention will become more readily apparent from the following disclosure, appended claims, and the attached drawings of a preferred embodiment of the invention.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 shows an isometric view of an apparatus for printing on spherically symmetrical objects according to various embodiments described herein.

FIG. 2 depicts an exploded view of an apparatus for printing on spherically symmetrical objects according to various embodiments described herein.

FIG. 3 illustrates a section view along I-I of an apparatus for printing on spherically symmetrical objects according to various embodiments described herein.

FIG. 4 shows a ball-cup assembly according to various embodiments described herein.

FIG. 5 depicts an exploded view of the ball-cup assembly according to various embodiments described herein.

FIG. 6 shows a ball-release assembly according to various embodiments described herein.

FIG. 7 depicts an exploded view of the ball-release assembly according to various embodiments described herein.

FIG. 8 shows a driving assembly according to various embodiments described herein.

FIG. 9 depicts an exploded view of the driving assembly according to various embodiments described herein.

FIG. 10 shows a baseplate assembly according to various embodiments described herein.

FIG. 11 depicts an exploded view of the driving assembly according to various embodiments described herein.

FIG. 12 shows how the present invention attaches to a rotary rack according to various embodiments described herein.

### DETAILED DESCRIPTION OF THE INVENTION

Reference will now be made in detail to a preferred embodiment of the invention, non-limiting examples of which are illustrated in the accompanying drawings.

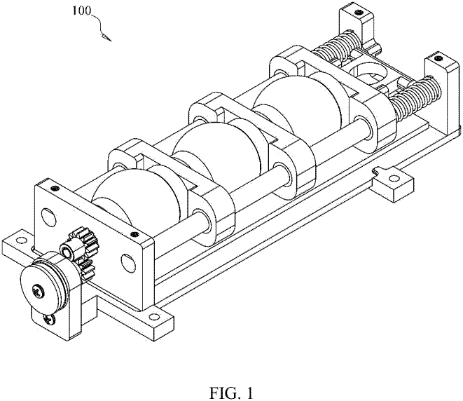

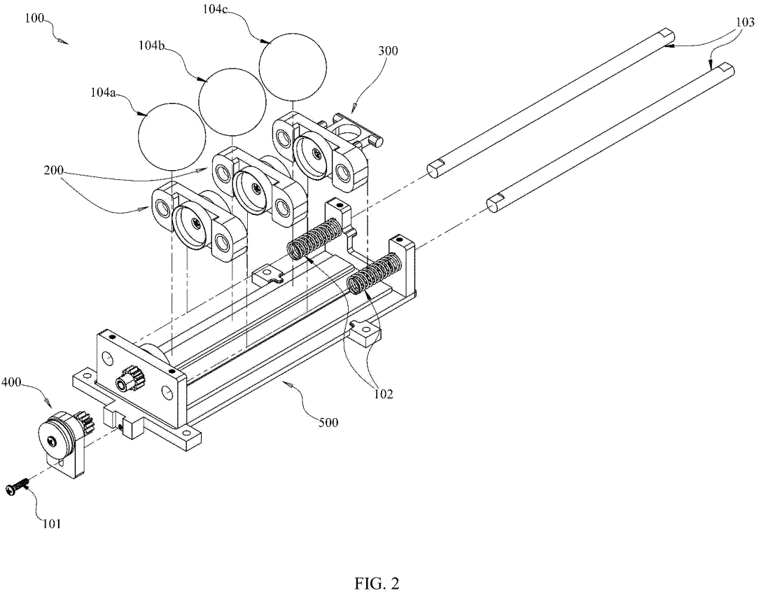

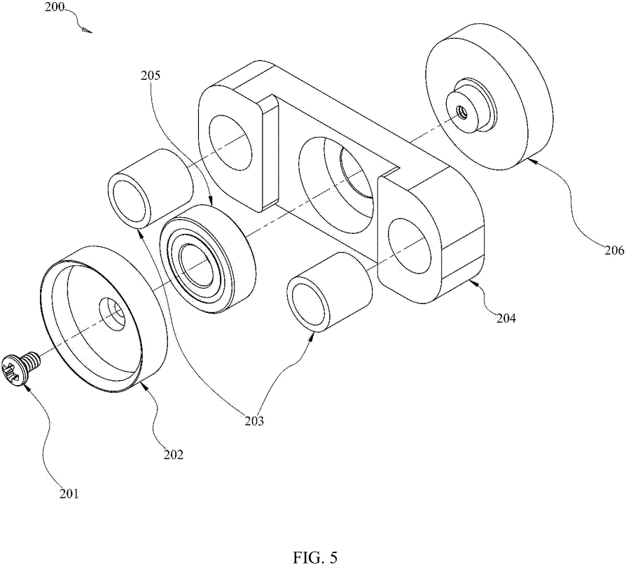

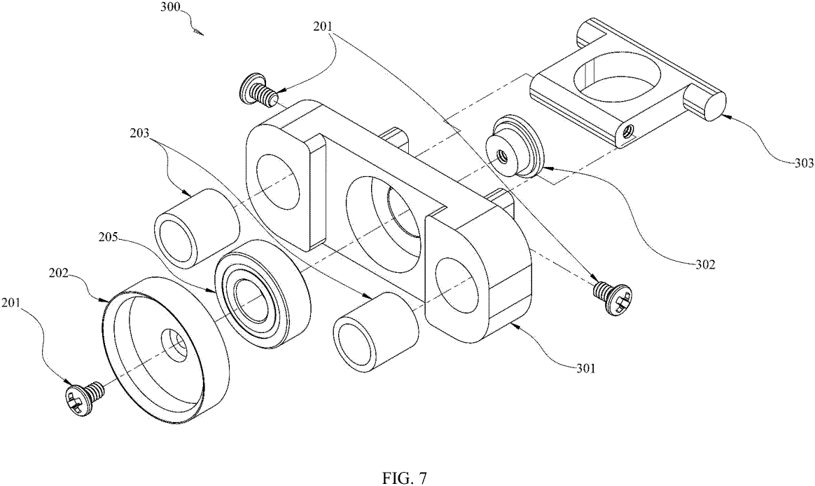

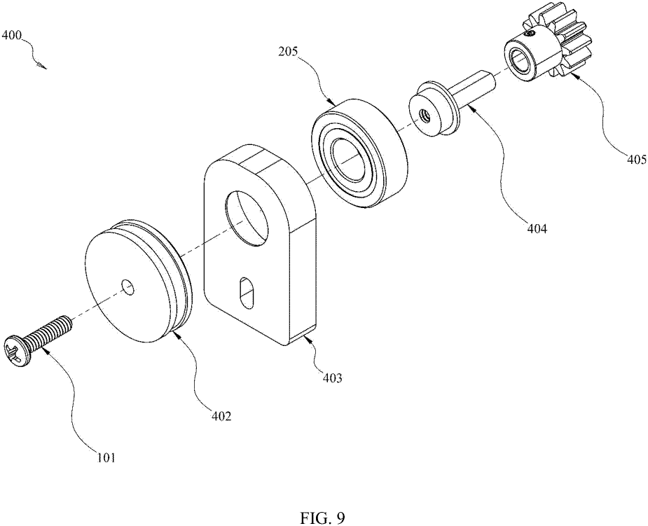

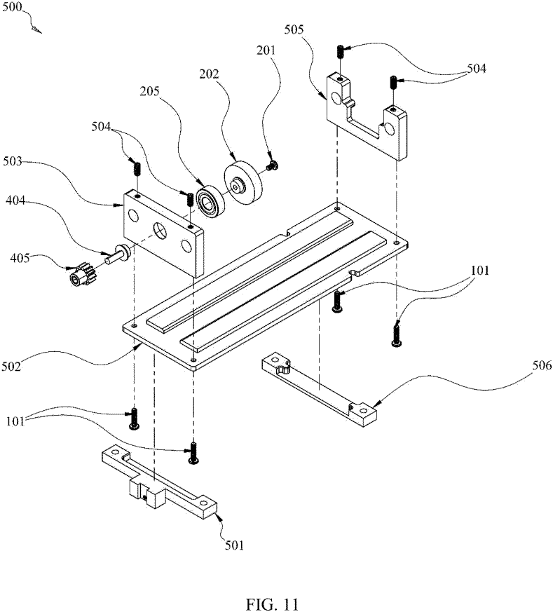

In FIG. 1, an apparatus for flatbed printing a plurality of spherically symmetrical objects 100 is shown. FIG. 2 depicts an exploded view of the apparatus 100, composed of four sub-assemblies: the ball-cup assembly 200, ball-release assembly 300, driving assembly 400, and baseplate assembly 500. Each assembly exploded view is shown in FIG. 5, FIG. 7, FIG. 9, and FIG. 11, respectively, showing all described components. The driving assembly 400 is fastened to the baseplate assembly 500 utilizing a fastener 101. Where the fastener 101 goes through a slotted hole in the pulley housing 403 and screws into a threaded hole in the quick-release driving mount 501. A pair of springs 102 are held within the assembly 100 by a pair of reload rods 103. These reload rods 103 insert into thru-holes on the reload end mount 505 and are secured into thru-holes on the driving end mount 503. Set screws 504 are used to secure the reload rods 103 by tightening onto the flats of the rods, screwing into the driving end mount 503 and reload end mount 505 to secure the rods 103. Finally, the spherically symmetrical objects 104a-104c are shown and are held in place by two varieties of cups: regular cups 202 and threaded cups 206.

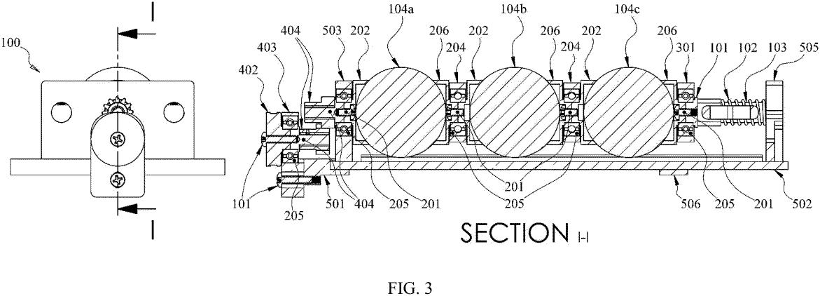

FIG. 3 shows section view I-I of the apparatus 100. This section view demonstrates how the spherically symmetrical objects 104a-104c are gripped. From this view, the leftmost object 104a is cupped by two regular cups 202 on both ends, the next object 104b is cupped by a threaded cup 206 on the left end and a regular cup 202 on the right end, and the subsequent object 104c is cupped similarly to the aforementioned object 104b.

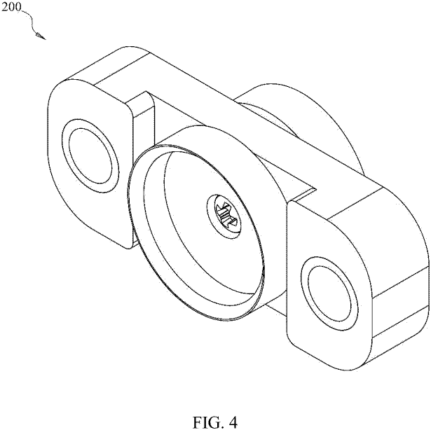

FIG. 4 shows the ball-cup assembly 200 as previously mentioned. FIG. 5 depicts an exploded view of the ball-cup assembly 200. The primary component of the ball-cup assembly 200 is the bearing mount 204 which features a bearing housing to hold a ball-bearing 205. Additionally, the bearing mount 204 includes two holes on the periphery of the part for press fitting oil-embedded sleeve bearings 203. The sleeve bearings 203 are slid onto the reload rods 103 and allow for smooth movement of the ball-cup assembly 200 along the reload rods 103. Finally, a regular cup 202 shaft is inserted into the bearing 205 on the front face and a threaded cup 206 shaft is inserted into the bearing on the opposite face. A fastener 201 is inserted into a thru-hole on the regular cup 202 and screwed into a threaded hole of the threaded cup 206 securing the two cups within the bearing mount 204 such that when the regular cup 202 rotates the threaded cup 206 also rotate.

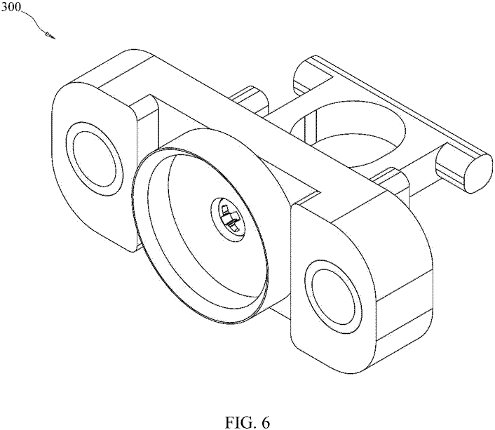

FIG. 6 shows the ball-reload assembly 300 as previously mentioned. FIG. 7 depicts an exploded view of the ball-reload assembly 300. The primary component of the ball-reload assembly 300 is the reload mount 301 which features a bearing housing to hold a ball-bearing 205. Additionally, the reload mount 301 includes two holes on the periphery of the part for the press fitting of oil-embedded sleeve bearings 203. The sleeve bearings 203 are slid onto the reload rods 103 and allow for smooth movement of the ball-reload assembly 300 along the reload rods 103. Continuing, a regular cup 202 shaft is inserted into the bearing 205 on the front face and an end cap 302 is inserted into the bearing on the opposite face. A fastener 201 is inserted into a thru-hole in the regular cup 202 and screwed into a threaded hole of the end cap 302. The end cap 302 is used to fasten the regular cup 202 for the ball-reload assembly 300 as it has a smaller profile compared to a threaded cup 206, allowing for the inclusion of the gripping handle 303. Tabs on the back of the reload mount 301 are used to mount the gripping handle 303 by way of a pair of fasteners 201. The fasteners 201 are loosely tightened into the threads of the gripping handle 303 so that the handle is free to rotate about the attachment point on the reload mount 301.

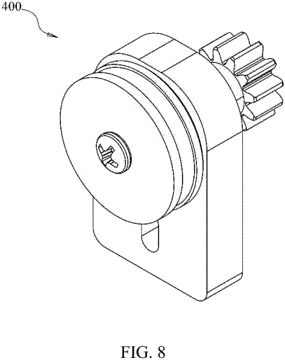

FIG. 8 shows the driving assembly 400 as previously mentioned. FIG. 9 depicts an exploded view of the driving assembly 400. The primary component of the driving assembly 400 is the pulley mount 403 which features a bearing housing to hold a ball-bearing 205. A pulley 402 is inserted into the front face of the bearing 205 and a keyed gear shaft 404 is inserted into the bearing on the opposite face. A fastener 101 is inserted into a thru-hole in the pulley 402 and screwed into a threaded hole of the keyed gear shaft 404. Finally, a gear with a hub and set screw 405 is secured onto the flat of the keyed gear shaft 404.

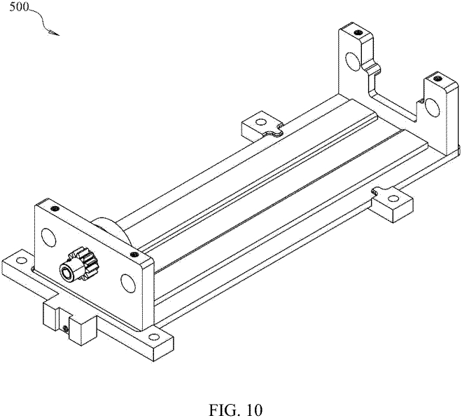

FIG. 10 shows the baseplate assembly 500 as previously mentioned. FIG. 11 depicts an exploded view of the baseplate assembly 500. The primary component of the baseplate assembly 500 is the baseplate 502. The baseplate 502 is of rectangular geometry and is what the spherically symmetrical objects 104a-c rest on while not contained by the cups 202/206. At the corners of the baseplate 502, fasteners 101 are inserted into counterbore holes on the bottom of the baseplate 502 to mount the driving end mount 503 at the front end and the reload end mount 505 at the back end of the baseplate 502. Additionally, the driving end mount 503 is configured with an assembly similar to the driving assembly 400 such that the driving end mount 503 contains a slot for a bearing 205 to be impressed where a regular cup 202 shaft is inserted into the back face of the bearing 205 and a keyed gear shaft 404 is inserted into the bearing on the front face, with a fastener 201 inserted through the regular cup 202 that is threaded into the keyed gear shaft 404. The gear with a hub and set screw 405 is then secured on the flat of the keyed gear shaft 404. Finally, a quick-release driving mount 501 press fits onto the front end of the baseplate 500 and a quick-release tab mount 506 inserts into tabs on the baseplate 500 securing the apparatus to the quick-release system.

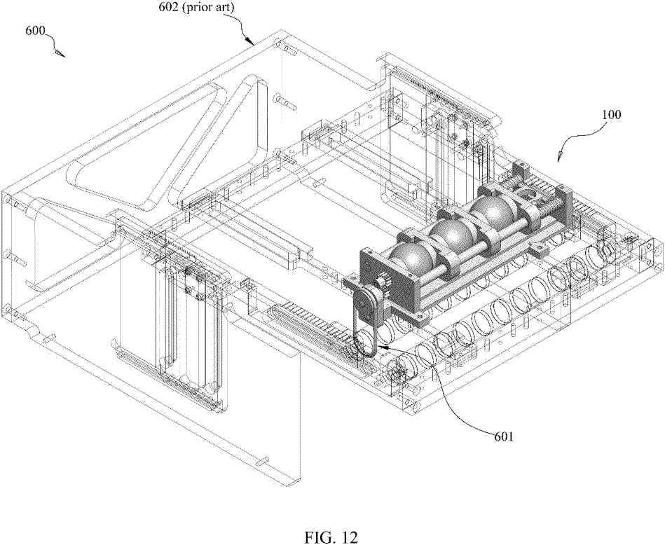

FIG. 12 shows how the present invention interacts with a rotary rack 602 (prior art). An O-ring 601 is seated in the groove of the driving assembly 400 onto the pulley 402. This O-ring 601 is then connected to the rollers of the rotary rack 602 (prior art). This connection allows for the rotational motion of the gripped spherically symmetrical objects 104a-c, enabling the ability to print across the circumference of the objects 104a-c.

What is claimed is:

1. An apparatus for printing onto spherically symmetrical objects, comprising: a quick-release system attaching to a rotary rack; a driving assembly that interfaces with the rotary rack to transfer motion from the rotary rack to the present invention; a holding fixture containing multiple detents between which a plurality of objects are held; and a spring used to assist in the reloading of objects between the detents.

2. The apparatus as in claim 1, wherein said quick-release system attaches to a pair of railings, via fasteners, on said rotary rack device.

3. The apparatus as in claim 1, wherein said driving assembly consists of an O-ring that interfaces with a roller of said rotary rack and transmits motion to a set of gears rotating the said detents between which the objects are held.

4. The apparatus as in claim 1, wherein said holding fixture comprises securing the object between two said detents.

5. The apparatus as in claim 1, wherein springs act to hold a series of said holding fixtures in place such that a plurality of said objects can be held and printed on simultaneously.

6. The apparatus as in claim 2, wherein said quick-release system binds said holding fixture in all degrees of freedom except one, allowing for the removal of said holding fixture from said quick-release system.

7. The apparatus as in claim 3, wherein said driving assembly attaches to said quick-release system to facilitate removal of said apparatus from said rotary rack to remove and reload said objects.

8. The apparatus as in claim 4, wherein said detents are formed to hold the partial volume of said object geometry to leave a prescribed amount of surface area available for imprinting upon.

9. The apparatus as in claim 5, wherein said springs affix to rods running transverse to said holding fixtures to facilitate the gripping of, and thus motion of, the said objects between said detents.

10. The apparatus as in in claim 8, wherein said detents are attached to each other within a housing containing a bearing allowing for a continuation of rotational motion throughout said holding fixture enabling the printing upon of a plurality of said objects at once.
